(19) United States
(12) Patent Application Publication
(10) Pub. No.: US 2023/0221906 A1
(43) Pub. Date: Jul. 13, 2023

(54) PRINTING FILE MANAGEMENT SYSTEM, PRINTING FILE MANAGEMENT METHOD, AND PRINTING FILE MANAGEMENT PROGRAM

(71) Applicant: SEIKO EPSON CORPORATION, Tokyo (JP)

(72) Inventor: Tetsuyuki MINAMIHARA, SHIOJIRI-SHI (JP)

(21) Appl. No.: 18/152,509

(22) Filed: Jan. 10, 2023

(30) Foreign Application Priority Data
Jan. 12, 2022 (JP) 2022-003018

(51) Int. Cl. G06F 3/12

(52) U.S. Cl. CPC G06F 3/1238; G06F 3/1222; G06F 3/1274

(57) ABSTRACT

A printing file management system includes a storage unit configured to cause a recording medium to store a printing file and a processing unit configured to set a storage period for the printing file based on a combination of a security level and repeat printing setting associated with the printing file stored in the recording medium and automatically delete the printing file when the storage period expires.

The present application is based on, and claims priority from JP Application Serial Number 2022-003018, filed Jan. 12, 2022, the disclosure of which is hereby incorporated by reference herein in its entirety.

### BACKGROUND

### 1. Technical Field

The present disclosure relates to a printing file management system, a printing file management method, and a printing file management program.

### 2. Related Art

There has been known a printer that stores a printing job file for reprinting. JP-A-2012-162041 (Patent Literature 1) states that, among printing jobs stored for reprinting, a printing job matching an attribute that should be deleted is preferentially deleted. Patent Literature 1 states that, for example, when a printing job is a secure printing job, the secure printing job is deleted when print processing ends or the secure printing job is deleted when a storage period exceeds a predetermined period.

When a printing file is stored in a server and managed, from the viewpoint of convenience, it is desirable to store the printing file. However, simply continuing to store the printing file leads to an increase in storage use cost of a Cloud server. Therefore, it has been desired to efficiently manage the printing file.

### SUMMARY

A printing file management system includes: a storage unit configured to cause a recording medium to store a printing file; and a processing unit configured to set a storage period for the printing file based on a combination of a security level and repeat printing setting associated with the printing file stored in the recording medium and automatically delete the printing file when the storage period expires.

A printing file management method includes: causing a recording medium to store a printing file; and setting a storage period for the printing file based on a combination of a security level and repeat printing setting associated with the printing file stored in the recording medium and automatically deleting the printing file when the storage period expires.

A non-transitory computer-readable storage medium stores a printing file management program, the printing file management program causing a computer to function as: a storage unit configured to cause a recording medium to store a printing file; and a processing unit configured to set a storage period for the printing file based on a combination of a security level and repeat printing setting associated with the printing file stored in the recording medium and automatically delete the printing file when the storage period expires.

### BRIEF DESCRIPTION OF THE DRAWINGS

FIG. 1 is a diagram schematically showing an example of a printing file management system.

FIG. 2 is a block diagram showing a configuration of a server.

FIG. 3 is a block diagram showing a configuration of an administrator terminal.

FIG. 4 is a block diagram showing a configuration of a printer.

FIG. 5 is a diagram showing an example of a printing file registration screen.

FIG. 6 is a diagram showing an example of security levels and repeat printing setting associated with printing files.

FIG. 7 is a diagram showing an example of a list screen of the printing files.

FIG. 8 is a diagram showing an example of the list screen of the printing files.

FIG. 9 is a diagram showing combinations of the security levels and the repeat printing setting and control content concerning automatic deletion.

FIG. 10 is a flowchart of automatic deletion processing.

### DESCRIPTION OF EXEMPLARY EMBODIMENTS

An embodiment of the present disclosure is explained according to order described below.
(1) System configuration
(1-1) Configuration of a server
(1-2) Configuration of an administrator terminal
(1-3) Configuration of a printer
(2) Registration of a printing file
(3) Automatic deletion of a printing file
(4) Other embodiments

### (1) System Configuration

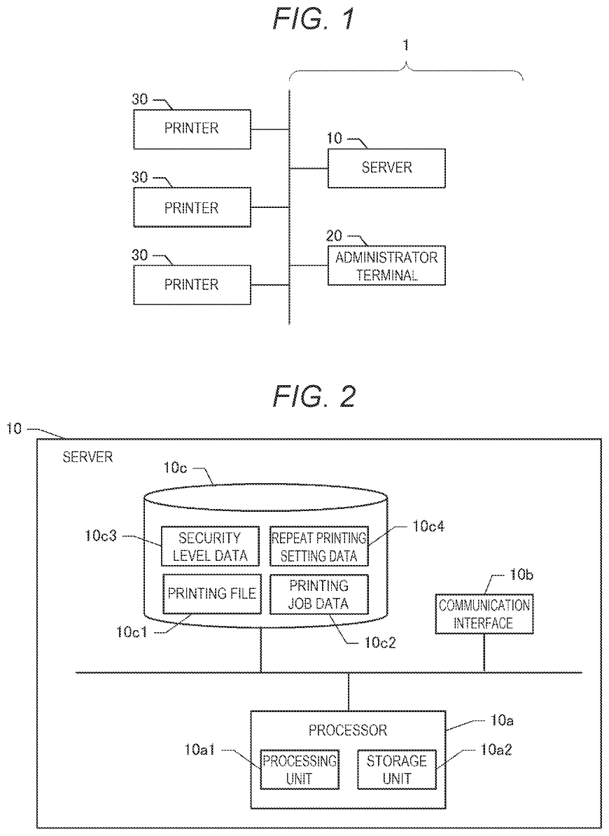

FIG. 1 is a diagram schematically showing an example of a system including a printing file management system according to an embodiment of the present disclosure. A printing file management system 1 includes a server 10 and an administrator terminal 20. The server 10 is connected to a plurality of printers 30. In this embodiment, the numbers of the illustrated devices are an example and are not limited. For example, the number of the plurality of printers 30 illustrated in FIG. 1 is not limited to the number illustrated in FIG. 1. For example, one administrator terminal 20 shown in FIG. 1 may be a plurality of administrator terminals 20. These devices can communicate with one another via a network. A form of the network may be various forms and may be a local network. The devices present in physically separated positions may communicate with one another via the Internet or the like.

In this embodiment, an administrator of the server 10 receives a printing request from a requester and, in order to deliver a requested print to the requester, causes the plurality of printers 30 to print the print. In this embodiment, the server 10 can collect printing statuses and the like in the printers 30. A user (an administrator) of the administrator terminal 20 can transmit a printing file to be printed acquired from the requester to the server 10 from the administrator terminal 20 and cause a recording medium of the server 10 to store the printing file. By operating the administrator terminal 20, the user of the administrator terminal 20 can cause a display of the administrator terminal 20 to display a list of printing files stored in the recording medium of the server 10 and can create printing jobs that target the stored printing files. In this embodiment, the printing file management system 1 has a function of setting a storage period for a printing file based on content set for the printing file by the administrator, operation content and an operation date and time for the printing file, a status of a printing job concerning the printing file, and the like and automatically deleting the printing file when the storage period expires.

In the following explanation, configurations of the devices of the printing file management system 1 capable of performing such automatic deletion are explained.

### (1-1) Configuration of the Server

FIG. 2 is a block diagram showing a configuration of the server 10. The server 10 includes a processor 10a, a communication interface 10b, and a nonvolatile memory 10c. The processor 10a includes a CPU, a ROM, and a RAM not shown in FIG. 2 and can execute various programs including a printing file registration program and an automatic deletion program recorded in the nonvolatile memory 10c and control the units of the server 10 and the devices connected to the network. The processor 10a may be configured by a single chip, may be configured by a plurality of chips, or may be configured as an SoC together with various functional blocks for causing the printers 30 to operate. For example, an ASIC may be adopted instead of the CPU or the CPU and the ASIC may cooperate. In this embodiment, the administrator terminal 20 and the printers 30 include processors. However, the processors can be realized in various forms like the processor 10a.

The communication interface 10b is a device for communicating with external equipment according to wired or wireless various communication protocols. The server 10 is capable of communicating with the other devices via the communication interface 10b. The communication interface 10b may include an interface for communicating with various removable memories installed in the server 10.

Other than the programs, various kinds of information are accumulated in the nonvolatile memory 10c (a recording medium) of the server 10. In this embodiment, a printing file 10c1, printing job data 10c2, security level data 10c3, and repeat printing setting data 10c4 are stored in the nonvolatile memory 10c.

The printing file 10c1 is a file including data indicating contents to be printed on a printing medium. For example, a pdf file can be the printing file 10c1. In this embodiment, information concerning a date and time (a registration date and time) when the printing file 10c1 is stored in the nonvolatile memory 10c, a date and time (an update date and time) when the printing file 10c1 is, for example, edited, and a date and time (an access date and time) when the printing file 10c1 is accessed is stored in the nonvolatile memory 10c by the processor 10a of the server 10 executing a file system program of an OS.

The printing job data 10c2 is data including various kinds of information concerning printing of a printing file. In this embodiment, the printing job data 10c2 includes information indicating a printing target, a printing status, a printing date and time, printing conditions, and the number of prints. The printing target is a file name indicating a file to be printed. The printing status is information indicating an execution state of a printing job. In this embodiment, the printing status includes “unprinted”, “printing”, and “printed”. The “unprinted” is a state in which the printing job is not executed yet. The “printing” is a state in which the printing job is executed. The “printed” is a state in which the execution of the printing job is completed. When the execution of the printing job is completed, a completion date and time is stored as a printing date and time.

The printing conditions are conditions necessary for realizing printing. For example, a type of a medium, resolution, and a color in use (color/monochrome) are defined as the printing conditions. The number of prints is the number of copies requested to be printed and is defined for each of printing targets. A plurality of printing job data 10c2 can be created for one printing file 10c1.

The security level data 10c3 is data indicating security levels set for printing files stored in the nonvolatile memory 10c. The security levels are degrees of confidentiality of information included in the printing files. In this embodiment, the security levels are set by the administrator when the administrator causes the nonvolatile memory 10c to store the printing files. For example, the administrator inquires a requester, who requests printing of a printing file, about a type of information included in the printing file and sets a security level according to the type. In this embodiment, the security level is represented by any one of three levels of high, medium, and low.

The repeat printing setting data 10c4 is data indicating whether there is possibility of repeatedly printing a printing file stored in the nonvolatile memory 10c. The repeat printing setting data 10c4 is defined about files. In this embodiment, the repeat printing setting data 10c4 is represented by ON or OFF. ON indicates that there is possibility of repeatedly printing the printing file 10c1 corresponding to the repeat printing setting data 10c4. In this embodiment, the repeat printing setting data 10c4 is set by the administrator when the administrator causes the nonvolatile memory 10c to store a printing file.

### (1-2) Configuration of the Administrator Terminal

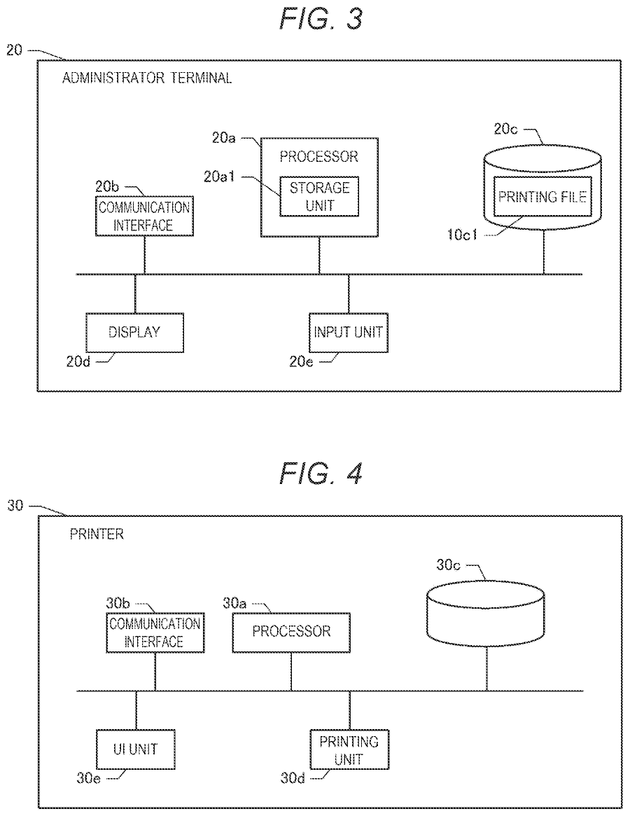

FIG. 3 is a block diagram showing a configuration of the administrator terminal 20. The administrator terminal 20 includes a processor 20a, a communication interface 20b, a nonvolatile memory 20c, a display 20d, and an input unit 20e. The processor 20a includes a CPU, a ROM, and a RAM not shown in FIG. 3 and can execute various programs including a printing file registration program recorded in the nonvolatile memory 20c and control the units of the administrator terminal 20.

The communication interface 20b includes a communication interface for communicating with external equipment according to wired or wireless various communication protocols. The administrator terminal 20 is capable of communicating with the other devices via the communication interface 20b. The communication interface 20b includes an interface for communicating with various removable memories installed in the administrator terminal 20.

The printing file 10c1 requested to be printed from a requester is recorded in the nonvolatile memory 20c of the administrator terminal 20. The printing file 10c1 may be recorded in the nonvolatile memory 20c in any form. For example, the printing file 10c1 prepared by the requester may be recorded in a removable memory and transferred from the removable memory to the nonvolatile memory 20c via the communication interface 20b. The printing file 10c1 may be acquired from an external device through the network. Further, the administrator may create the printing file 10c1 with an application program or the like using the administrator terminal 20 and record the printing file 10c1 in the nonvolatile memory 20c. Naturally, the administrator may edit a document created by the requester and record the document in the nonvolatile memory 20c as the printing file 10c1. When registering the printing file 10c1 in the server 10, the administrator designates the printing file 10c1 with a file name of the printing file 10c1 recorded in the nonvolatile memory 20c. The designated printing file 10c1 is transferred to the server 10 and stored in the nonvolatile memory 10c of the server 10.

The display 20d is a display device that displays any image. The input unit 20e is a device with which the administrator performs input operation and is configured by, for example, a keyboard, a mouse, or a touch panel. In any case, the administrator can operate the input unit 20e and input intention of the administrator while visually recognizing images and characters displayed on the display 20d. In this embodiment, the administrator uses the display 20d and the input unit 20e of the administrator terminal 20 as a user interface and, when transferring the printing file 10c1 to the server 10 and registering the printing file 10c1 in the server 10, sets presence or absence of repeat printing and a security level of the printing file 10c1. Details are explained below.

### (1-3) Configuration of the Printer

FIG. 4 is a block diagram showing a configuration of the printer 30. The printer 30 includes a processor 30a, a communication interface 30b, a nonvolatile memory 30c, a printing unit 30d, and a UI unit 30e. The processor 30a includes a CPU, a ROM, and a RAM not shown in FIG. 4 and can execute various programs recorded in the nonvolatile memory 30c and control the units of the printer 30.

The communication interface 30b includes a communication interface for communicating with external equipment according to wired or wireless various communication protocols. The printer 30 is capable of communicating with the other devices via the communication interface 30b. The communication interface 30b may include an interface for communicating with various removable memories installed in the printer 30.

The printing unit 30d is a part that executes printing. Various printing schemes such as an ink-jet scheme and an electrophotographic scheme may be adopted. The printing unit 30d includes an actuator and various devices, sensors, driving circuits, and mechanical components for executing printing on various media. The sensors include a sensor that detects various detection targets that can change in the printer 30. The detection targets are not limited. Examples of the sensor include a sensor that detects a residual amount of media and a sensor that detects a residual amount of ink for each of colors.

The UI unit 30e includes a touch panel display, various keys and switches, and the like. The touch panel display includes a display panel that displays various kinds of information, for example, a status of the printer 30 and a residual amount of ink and a touch detection panel superimpose on the display panel. The touch panel display detects touch operation by a human finger or the like. The processor 30a can acquire operation content of the administrator via the UI unit 30e. The processor 30a can display various kinds of information on the display of the UI unit 30e and notify the information to the user.

When the administrator instructs, through the administrator terminal 20, printing of the printing file 10c1 stored in the nonvolatile memory 10c, the server 10 instructs the printer 30 to start printing. At this time, the server 10 performs various kinds of image processing based on the printing file 10c1 to be printed and outputs printing data indicating content to be printed to the printer 30 via the communication interface 10b. The processor 30a of the printer 30 acquires the printing data via the communication interface 30b, controls the printing unit 30d based on the printing data, and carries out printing. When the printing ends, the processor 30a outputs information indicating that the printing ends to the server 10 via the communication interface 30b. When the server 10 acquires the information via the communication interface 10b, the processor 10a stores a date and time when the information is acquired in printing job data as a printing date and time.

### (2) Registration of the Printing File

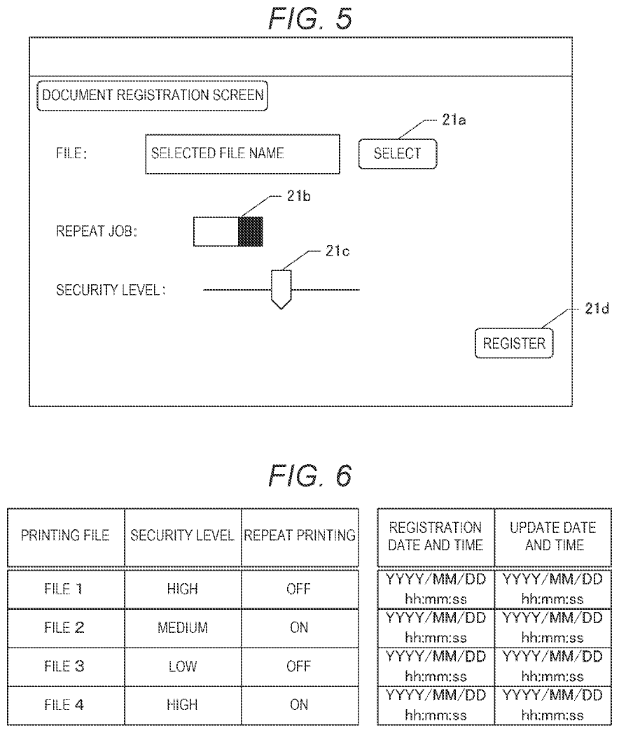

Subsequently, the registration of the printing file 10c1 to be printed acquired from the requester in the server 10 is explained in detail. The processor 20a of the administrator terminal 20 can cause, by executing a printing file registration program, the display 20d to display a printing file registration screen. FIG. 5 is a diagram showing an example of the printing file registration screen. The administrator can designate, via the printing file registration screen, a printing file that the administrator desires to register and repeat printing setting and a security level of the printing file and register the printing file in the server 10. Specifically, the administrator can select, with a printing-file selecting section 21a, out of files stored in the administrator terminal 20, the printing file 10c1 that the administrator desires to register in the server 10. The administrator can set, with a repeat-job setting section 21b, presence or absence (ON/OFF) of repeat printing setting for the printing file 10c1 selected by the printing-file selecting section 21a. The administrator can designate, with a security-level setting section 21c, any one of high, medium, and low as a security level of the printing file 10c1. When a registering section 21d is operated after designations by the printing-file selecting section 21a, the repeat-job setting section 21b, and the security-level setting section 21c are performed, the processor 20a transfers the printing file 10c1, the repeat printing setting data 10c4, and the security level data 10c3 to the server 10. In this case, the processor 20a of the administrator terminal 20 functions as the storage unit.

When executing the printing file registration program to thereby receive the printing file 10c1, the repeat printing setting data 10c4, and the security level data 10c3 from the administrator terminal 20, the processor 10a of the server 10 causes the nonvolatile memory 10c to store the printing file 10c1, the repeat printing setting data 10c4, and the security level data 10c3 in association with one another. In this case, the processor 10a of the server 10 functions as the storage unit. That is, as shown in FIG. 6, the security level data 10c3 and the repeat printing setting data 10c4 are stored in association with each other for each of printing files. Registration date and times of the printing files are date and times when the printing files are stored anew. Update date and times of the printing files are date and times when the printing files are edited, overwritten, and stored. These date and times are managed by a file system program executed by the server 10.

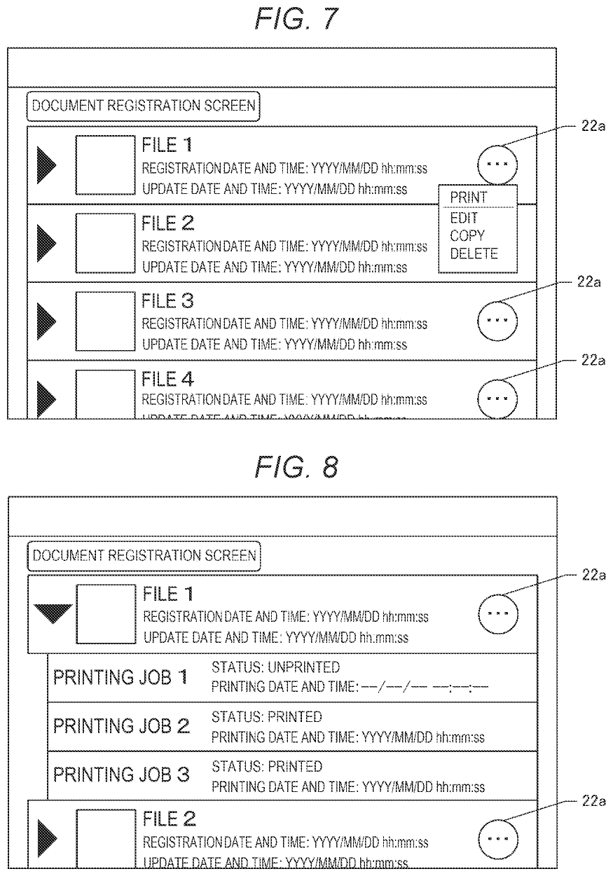

FIG. 7 is an example of a list screen of printing files 10c1 registered in the nonvolatile memory 10c of the server 10. When the administrator operates the administrator terminal 20 and selects display of the list screen, the processor 20a can cause the display 20d to display the list screen shown in FIG. 7.

As shown in FIG. 7, file operation sections 22a are displayed respectively in association with the printing files 10c1 shown in a list. By operating the file operation section 22a of any printing file 10c1, the administrator is capable of designating printing (creation of a printing job), editing, copying, and deletion of the printing file 10c1.

By instructing printing for the printing file 10c1, the administrator can select a printer at an output destination, set other printing conditions, the number of prints, and the like, and instruct printing. The processor 20a of the administrator terminal 20 transmits the set information to the server 10. The processor 10a of the server 10 generates, based on the transmitted information, printing data in a format suitable for the printer 30 at the output destination and transmits the printing data to the printer 30. The printer 30 executes printing based on the received printing data. When completing the printing, the printer 30 transmits information indicating that the printing is completed to the server 10. When acquiring the information, the processor 10a of the server 10 stores a date and time when the information is acquired in the printing job data as a printing date and time.

FIG. 8 is an example of a list screen of printing jobs displayed when any printing file 10c1 in the list of the printing files 10c1 shown in FIG. 7 is selected. The processor 20a of the administrator terminal 20 inquires the server 10, acquires statuses and printing date and times of the printing job data 10c2 associated with the printing file 10c1 set as a target, and displays the statuses and the printing date and times for each of the printing jobs.

As shown in FIG. 7, editing, copying, and deletion are present as other operation that the administrator can perform on the printing file 10c1. The editing is opening the target printing file 10c1 and editing content of the printing file 10c1. For example, the editing can be performed for final check of a pattern and a sentence and adjustment of a tint. When the editing is performed and the printing file 10c1 is overwritten and stored, the update date and time of the printing file 10c1 changes to an overwriting and storage date and time. When the printing file 10c1 is not edited at all after registration, a registration date and time and an update date and time are the same date and time.

The copying is duplicating the target printing file 10c1 in the nonvolatile memory 10c of the server 10. In a printing file stored anew by the duplication, a date and time stored anew is a registration date and time. The deletion is deleting the target printing file 10c1 from the nonvolatile memory 10c of the server 10. The deletion is equivalent to manual deletion by the administrator.

### (3) Automatic Deletion of the Printing File

Subsequently, automatic deletion of the printing file 10c1 performed in the server 10 is explained in detail. By executing an automatic deletion program, the processor 10a of the server 10 sets a storage period for a printing file based on a combination of a security level and repeat printing setting associated with the printing file stored in the nonvolatile memory 10c and automatically deletes the printing file when the storage period expires. In this case, the processor 10a functions as the processing unit.

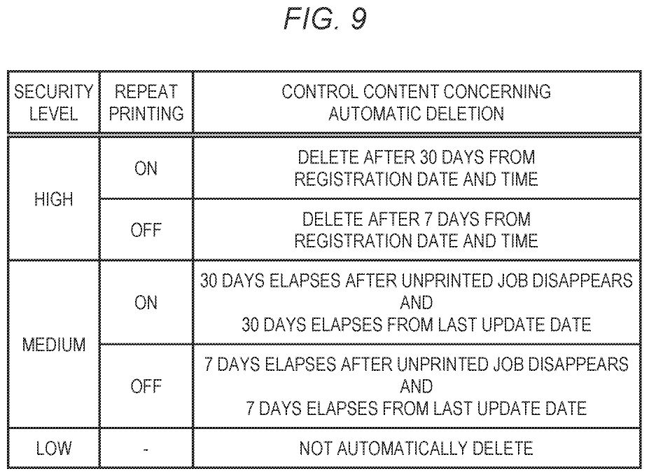

FIG. 9 is a diagram showing combinations of the security levels and the repeat printing setting and control content concerning the automatic deletion. As shown in FIG. 9, in this embodiment, when a security level of a printing file is “high (equivalent to a predetermined value)”, a storage period is set starting from a registration date of the printing file. When the repeat printing setting for the printing file 10c1 is ON, a storage period longer than a storage period at the time when the repeat printing setting is OFF is set for the printing file 10c1. Specifically, when the security level is “high” and the repeat printing setting is ON, the processor 10a automatically deletes the printing file 10c1 after thirty days from the registration date and time. When the security level is “high” and the repeat printing setting is OFF, the processor 10a automatically deletes the printing file 10c1 after seven days from the registration date and time.

In this embodiment, when the security level of the printing file is “medium”, the printing file is controlled to be continuously stored while an uncompleted printing job concerning the printing file is present. When the security level of the printing file is “medium”, the printing file is controlled to be deleted when both of periods indicated by the following two conditions elapse. A first condition is that X days elapse from a date and time when an unprinted job disappears (that is, all printing jobs is completed). Every time all printing jobs created for the printing file are completed, the processor 10a extends the storage period with the latest execution completion date set as a new starting point. A second condition is that X days elapse from a last update date of the printing file. The processor 10a extends the storage period for the printing file with the last update data of the printing file set as a new starting point. When the repeat printing setting for the printing file 10c1 is ON, a storage period longer than a storage period at the time when the repeat printing setting is OFF is set for the printing file 10c1. Specifically, when the security level is “medium” and the repeat printing setting is ON, the processor 10a automatically deletes the printing file 10c1 when thirty days or more elapse after an uncompleted printing job disappears and thirty days or more elapse from the last update date. When the security level is “medium” and the repeat printing setting is OFF, the processor 10a automatically deletes the printing file 10c1 when seven days or more elapse after an uncompleted printing job disappears and seven days or more elapse from the last update date.

In this embodiment, when the security level of the printing file is “low”, the printing file is controlled not to be automatically deleted. In this way, in this embodiment, when a predetermined period elapses from the registration date and time, the printing file having the security level “high” is automatically deleted irrespective of the latest printing completion date and time and the latest editing date and time. The administrator sometimes considers it unpreferable that a printing file having a high security level continues to remain in the nonvolatile memory 10c of the server 10. In the case of this embodiment, according to such a need of the administrator, it is possible to prevent the printing file having the security level “high” from continuing to remain in the nonvolatile memory 10c of the server 10 without being deleted and, therefore, it is possible to prevent storage use cost from uselessly increasing. In this embodiment, the storage period for the printing file having the security level “medium” is extended starting from the latest printing date and time or the latest update date and time. Therefore, since the printing file is not automatically deleted until a predetermined period elapses after operation for the printing file is not performed, it is unnecessary to register the printing file again from the administrator terminal 20 when printing and editing for the same printing file are performed again. Since the printing file is automatically deleted when the predetermined period elapses after the operation for the printing file is not performed, it is possible to prevent a printing file having low possibility of being operated again by the administrator from continuing to remain in the nonvolatile memory 10c. Further, when the security level is “high” and when the security level is “medium”, the printing file is automatically deleted earlier when the repeat printing setting is OFF than when the repeat printing setting is ON. Therefore, it is possible to automatically delete a printing file having low possibility of being reprinted earlier than a printing file having high possibility of being reprinted.

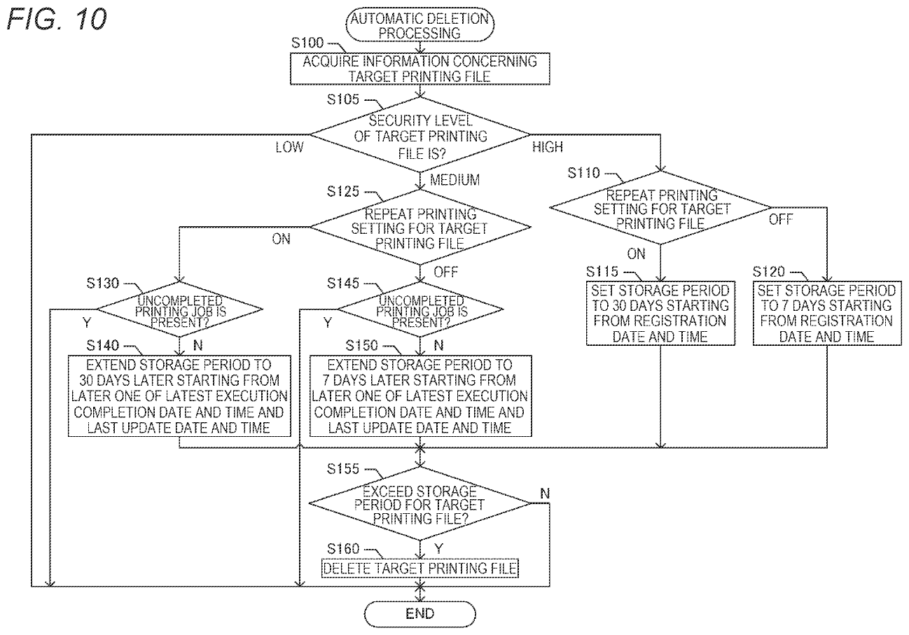

Subsequently, a flow of automatic deletion processing is explained with reference to FIG. 10. The automatic deletion processing is processing periodically (for example, every 24 hours) executed for each file targeting all the printing files 10c1 stored in the nonvolatile memory 10c of the server 10. That is, in one automatic deletion processing, one printing file set as a target is processed. The automatic deletion processing is repeatedly executed for all the printing files. When the automatic deletion processing is started, the processor 10a acquires information concerning a target printing file (step S100). That is, the processor 10a acquires the printing job data 10c2, the security level data 10c3, the repeat printing setting data 10c4, a registration date and time, and an update date and time of the target printing file 10c1.

Subsequently, the processor 10a determines which of high, medium, and low a security level of the target printing file is (step S105). That is, the processor 10a refers to the security level data 10c3 of the target printing file 10c1 and determines which of high, medium, and low the security level is.

When determining in step S105 that the security level is “high”, the processor 10a determines repeat printing setting for the target printing file (step S110). That is, the processor 10a refers to the repeat printing setting data 10c4 of the target printing file 10c1 and determines whether the repeat printing setting is ON or OFF. When determining in step S110 that the repeat printing setting is ON, the processor 10a sets a storage period for the target printing file to thirty days starting from the registration date and time of the printing file (step S115). When determining in step S110 that the repeat printing setting is OFF, the processor 10a sets the storage period for the target printing file to seven days starting from the registration date and time of the printing file (step S120).

When determining in step S105 that the security level of the target printing file is “medium”, the processor 10a determines repeat printing setting for the target printing file (step S125). When determining in step S125 that the repeat printing setting is ON, the processor 10a determines, for the target printing file, whether an uncompleted printing job is present (step S130). That is, the processor 10a refers to statuses of all the printing job data 10c2 of the target printing file 10c1 and determines whether an unprinted printing job is present. When determining in step S130 that an uncompleted printing job is present, the processor 10a ends the automatic deletion processing for the target printing file.

When not determining in step S130 that an uncompleted printing job is present, the processor 10a extends the storage period until thirty days later starting from later one of the latest execution completion date and time and the last update date and time of the printing for the target printing file (step S140). That is, the processor 10a acquires printing date and times of all printing jobs of the target printing file 10c1 and an update date and time of the target printing file 10c1 and sets thirty days starting from later one of the printing date and times and the update date and time as the storage period.

When determining in step S125 that the repeat printing setting is OFF, the processor 10a determines, for the target printing file, whether an uncompleted printing job is present (step S145). When determining in step S145 that an uncompleted printing job is present, the processor 10a ends the automatic deletion processing for the target printing file.

When not determining in step S145 that an uncompleted printing job is present, the processor 10a extends the storage period until seven days later starting from later one of the latest execution completion date and time and the last update date and time of the printing for the target printing file (step S150).

After executing any one of steps S115, S120, S140, and S150, the processor 10a determines whether the storage period for the target printing file has expired (step S155). That is, the processor 10a determines whether the present date and time exceeds a date and time that is an end point of the storage period.

When determining in step S155 that the storage period has expired, the processor 10a deletes the target printing file (step S160) and ends the automatic deletion processing. When not determining in step S155 that the storage period has expired, the processor 10a ends the automatic deletion processing without deleting the target printing file.

### (4) Other Embodiments

The embodiment explained above is an example for carrying out the present disclosure. Other various embodiments can be adopted. For example, in the embodiment explained above, the server 10 and the administrator terminals 20 are configured by the different devices. However, the server 10 and the administrator terminals 20 may be the same device or may be distributed to three or more devices. Further, the order of interchangeable processing may be changed. The forms of the related screens and the forms of the printing job data 10c2, the security level data 10c3, the repeat printing setting data 10c4, and the like are examples. Different forms may be adopted.

The processing unit only has to be able to set a storage period for a printing file based on a combination of a security level and repeat printing setting associated with the printing file. A configuration may be adopted in which the storage period is shorter or automatic deletion conditions are further relaxed as the security level is higher. The security level may be represented by any one of three or more levels or less than three levels. In the embodiment, when the security level is “low” the printing file is not automatically deleted. However, the printing file may be automatically deleted even when the security level is “low”. In that case, a storage period longer than a storage period at the time when the security level is “medium” may be set. The printing file having the security level “high” also may not be automatically deleted while an uncompleted printing job is present.

Further, when the same printing file, the repeat printing setting for which is OFF, is printed a plurality of times within a fixed period, a configuration may be adopted in which a proposal for changing the repeat printing setting corresponding to the printing file to ON is performed and, when the administrator accepts the proposal, the repeat printing setting for the printing file is changed to ON. In the case of the configuration in which the storage period is longer when the repeat printing setting is ON than when the repeat printing setting is OFF, by proposing to change repeat printing setting for a printing file printed at a high frequency within the fixed period to ON, it is possible to urge the administrator to extend the storage period until automatic deletion of the printing file.

Further, when the security level of the printing file is equal to or higher than a predetermined value, a storage period may be extended starting from a last update date of the printing file.

The security level is not limited to be set by the user when the printing file is stored in the recoding medium. For example, when a specific character or pattern related to the security level is included in the printing file or when a specific character is included in a printing file name, a security level indicated by the character or the pattern may be automatically set for the printing file. The security level may be able to be set or changed at any timing other than the registration time of the printing file. A requested security level of the printing file may be determined for each of requesters. The repeat printing setting may be changeable by the user at any timing other than the registration time of the printing file.

Further, the present disclosure is also applicable as a program or a method executed by a computer. The system, the program, and the method explained above are realized as an independent device in some cases and are realized using components included in a plurality of devices in other cases and include various forms. The system, the program, and the method are changeable as appropriate to be, for example, partially software or partially hardware. Further, the disclosure is also realized as a storage medium of a program for controlling the system. Naturally, the recording medium of the program may be a magnetic recording medium or may be a semiconductor memory. Any recording medium to be developed in future can be considered completely the same.

What is claimed is:

1. A printing file management system comprising:
a storage unit configured to cause a recording medium to store a printing file; and
a processing unit configured to set a storage period for the printing file based on a combination of a security level and repeat printing setting associated with the printing file stored in the recording medium and automatically delete the printing file when the storage period expires.

2. The printing file management system according to claim 1, wherein the storage unit receives the security level and the repeat printing setting set by a user for the printing file.

3. The printing file management system according to claim 1, wherein the security level is represented by any one of three or more levels.

4. The printing file management system according to claim 1, wherein the processing unit sets, for the printing file, the storage period longer when the repeat printing setting for the printing file is ON than when the repeat printing setting is OFF.

5. The printing file management system according to claim 1, wherein, when the same printing file, the repeat printing setting for which is OFF, is printed a plurality of times within a fixed period, the processing unit performs a proposal for changing the repeat printing setting corresponding to the printing file to ON and, when a user accepts the proposal, changes the repeat printing setting for the printing file to ON.

6. The printing file management system according to claim 1, wherein the processing unit extends the storage period for the printing file with a last update date of the printing file set as a new starting point.

7. The printing file management system according to claim 1, wherein
when the security level of the printing file is equal to or higher than a predetermined value, the processing unit sets the storage period starting from a registration date of the printing file, and
when the security level of the printing file is lower than the predetermined value, the processing unit continues the storage of printing file while an uncompleted printing job concerning the printing file is present and, every time execution of all printing jobs for the printing file is completed, extends the storage period with a latest execution completion date set as a new starting point.

8. A printing file management method comprising:
causing a recording medium to store a printing file; and
setting a storage period for the printing file based on a combination of a security level and repeat printing setting associated with the printing file stored in the recording medium and automatically deleting the printing file when the storage period expires.

9. A non-transitory computer-readable storage medium storing a printing file management program, the printing file management program causing a computer to function as:
a storage unit configured to cause a recording medium to store a printing file; and
a processing unit configured to set a storage period for the printing file based on a combination of a security level and repeat printing setting associated with the printing file stored in the recording medium and automatically delete the printing file when the storage period expires.
